(19) United States
(12) Patent Application Publication
(10) Pub. No.: US 2020/0052800 A1
(43) Pub. Date: Feb. 13, 2020

(54) COMMUNICATION IN FLUID MEDIUM USING MOTOR MODULATION

(71) Applicant: Embry-Riddle Aeronautical University, Inc., Daytona Beach, FL (US)

(72) Inventors: Brian Butka, Palm Coast, FL (US); Jefferson Romney, South Daytona, FL (US)

(21) Appl. No.: 16/538,471

(22) Filed: Aug. 12, 2019

Related U.S. Application Data
(60) Provisional application No. 62/718,280, filed on Aug. 13, 2018.

(51) Int. Cl. H04B 13/02; H04B 11/00; G10K 15/04; B63H 21/17

(52) U.S. Cl. CPC H04B 13/02; B63H 21/17; G10K 15/04; H04B 11/00

(57) ABSTRACT

Aquatic vehicles may use electric motors for propulsion, such as brushless motors. As an example, a speed of these motors can be controlled using a pulse-width-modulated (PWM) electrical signal that varies the motor speed by varying pulse parameters within the PWM signal. PMW modulation can cause the motor to emit significant acoustic noise into the environment. In a fluid medium, such as aquatic environment, such noise can be detected with hydrophones or other acoustic sensors. The subject matter described herein can include modulating a signal provided to a motor to provide a communication signal to be mechanically (e.g., acoustically) emitted by the motor in a fluid medium, such as an underwater medium. In this manner, the motor can function both as a source of propulsion, and as an electroacoustic transducer (e.g., a transmitter).

### CLAIM OF PRIORITY

This patent application claims the benefit of priority of Butka et al., U.S. Provisional Patent Application Ser. No. 62/718,280, titled “COMMUNICATION IN FLUID MEDIUM USING MOTOR MODULATION,” filed on Aug. 13, 2018 (Attorney Docket No. 4568.005PRV), which is hereby incorporated by reference herein in its entirety.

### STATEMENT REGARDING FEDERALLY SPONSORED RESEARCH OR DEVELOPMENT

This invention was made with government support under N0014-17-1-2492 awarded by Office of Naval Research (ONR). The government has certain rights in the invention.

### FIELD OF THE DISCLOSURE

This document pertains generally, but not by way of limitation, to communication through a fluid, such as water, using mechanical vibration (e.g., acoustic communication), and more particularly to electro-acoustic communication.

### BACKGROUND

An autonomous or semi-autonomous maritime system can have a fleet of unmanned vehicles operating in a coordinated manner in one or more of aerial, water surface, or underwater domains. Communication between surface and air vehicles can be accomplished using radio frequency or optical communication links, which are generally highly reliable and offer a high bandwidth (e.g., hundreds of kilobits per second or greater data transfer rates). However, radio frequency and optical communication links generally perform poorly underwater. In one approach. communication through a fluid medium, such as water, can be performed using a dedicated electro-acoustic transducer as a transmitter. For example, an ultrasound transducer can be used. An acoustic signal transmitted by an electro-acoustic transducer can be received by a hydrophone or other sensor.

### SUMMARY OF THE DISCLOSURE

Generally, underwater communication systems are acoustic-based systems having limited analog signal bandwidth and accordingly, a relatively limited data rate. Challenges related to underwater vehicles or systems include that a limited range and a limited bandwidth of undersea acoustic links can restrict capacity for command and control, such as inhibiting manned and unmanned teaming options for undersea systems. Another challenge is that recovery of unmanned vehicles by submarines or surface ships can be difficult and costly.

The present inventors have recognized, among other things, that a low-cost communication system can facilitate docking or rendezvous of an unmanned underwater vehicle (UUV) with an unmanned surface vehicle (USV), or other communication between such vehicles. In some approaches, underwater communication focuses on achieving bidirectional high data-rate communications over long distances, but an UUV/USV application can involve unidirectional (e.g., “one way”) low data-rate communication.

Underwater acoustic communication links generally operate in a challenging propagation environment. Adverse effects include reflections from the water surface or the sea bottom that can interfere with the signal reception, surface scattering of the signal, signal attenuation increasing rapidly with frequency thereby limiting the system range and bandwidth, and variations in the local environment. The effects of these rapidly changing propagation characteristics can be referred to generally as channel fading effects.

Aquatic vehicles can use electrically-operated motors for propulsion (e.g., in applications such as thrusters or “propulsors”), and such motors can include brushless motors. As an example, a speed of these motors can be controlled using a pulse-width-modulation (PWM) electrical signal that varies the motor speed by varying pulse parameters within the PWM signal. PMW modulation can cause the motor to emit significant acoustic noise into the environment. in a fluid medium, such as aquatic environment, such noise can be detected with hydrophones or other acoustic sensors. The subject matter described herein can include modulating a signal provided to a motor to provide a communication signal to be mechanically (e.g., acoustically) emitted by the motor in a fluid medium, such as an underwater medium. Providing a signal to the motor can include imposing a communication signal upon an electric signal used to provide propulsion energy to the motor or by modifying such a propulsion signal. In this manner, the motor can function in a normal manner as source of mechanical propulsion, and as an electro-acoustic transducer (e.g., an acoustic transmitter). Various examples described herein include use of such an electro-acoustic transmission scheme to provide a

navigation aid or docking aid, as illustrative examples. Such techniques are applicable to communication between underwater vehicles, communication between underwater and surface vehicles, and between surface vehicles.

In an example, an electromechanical communication system can include an electrically-powered propulsion motor mechanically coupled to a vehicle, the propulsion motor configured to provide mechanical propulsion in a fluid medium, and a control circuit coupled to the propulsion motor, the control circuit configured to generate an electrical signal to the propulsion motor including a portion corresponding to operating energy for the propulsion motor to use in providing thrust, and a portion corresponding to a transmission signal to be acoustically transmitted through the fluid medium by the propulsion motor acting as an electromechanical transducer. In an example, a signal processor can be configured to process a signal received from an acoustic receiver to determine at least one of a location, a distance, a relative bearing, or a locus of relative bearings, relative to the vehicle housing the electrically-powered propulsion motor. For example, the signal processor can be configured to determine a relative degree of angular error between an acoustic receiver location and a specified axis extending from the vehicle housing the electrically-powered propulsion motor.

In an example, a technique, such as a method, can include controlling an electrically-powered propulsion motor, the propulsion motor configured to provide mechanical propulsion in a fluid medium, the technique comprising generating an electrical signal to the propulsion motor including a portion corresponding to operating energy for the propulsion motor to use in providing thrust and a portion corresponding to a transmission signal to be acoustically transmitted by the propulsion motor acting as an electromechanical transducer. For example, the portion corresponding to the transmission signal can include a first modulation signal to be acoustically transmitted in a first direction and a different second modulation signal to be acoustically transmitted in a different second direction.

In an example, a technique, such as a method can include receiving an acoustic signal transmitted by an electrically-powered propulsion motor, the propulsion motor configured to provide mechanical propulsion in a fluid medium, the technique comprising, using an acoustic receiver, receiving a transmission signal acoustically transmitted by the propulsion motor acting as an electromechanical transducer, processing the received signal to provide an electrical signal representative of the received transmission signal, and, using the electrical signal, determining an indication of a location of the acoustic receiver relative to the propulsion motor. The transmission signal is at least one of added to a signal corresponding to the operating energy for the propulsion motor or established by modifying the signal corresponding to the operating energy for the propulsion motor.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an electro-acoustic communication system including a transmitter circuit and a receiver circuit.

FIG. 2A shows illustrative examples of pulse-width modulation waveforms having the same duty cycle (and the same average value) but having different frequencies.

FIG. 2B shows an illustrative example of a noise spectrum of a six kilowatt motor being driven using a six kilohertz (kHz) pulse-width-modulation (PWM) waveform.

FIG. 3A shows an illustrative example of a sine wave and a corresponding pulse-width modulated representation of the sine wave.

FIG. 3B shows an illustrative example of techniques for encoding information in a pulse sequence, such as using a Manchester encoding scheme.

FIG. 4A shows an illustrative example of a 24 kHz spectrum corresponding to a PWM output from a Castle Creations Electronic Speed Controller (ESC).

FIG. 4B shows an illustrative example of a spectrum corresponding to a 17.5 kHz PWM output from an Afro ESC.

FIG. 5 shows an illustrative example of experimentally detected amplitude-modulated data that was transmitted using a carrier frequency of 1080 Hertz (Hz).

FIG. 6 shows an illustrative example of experimentally detected start and stop bits corresponding to frequency-shift keyed data encoded using PWM frequencies of 15 kHz for start and stop bits, 17 kHz for “zero” (logic low) and 19 kHz for “one” (logic high).

FIG. 7 shows an illustrative example of experimentally-recovered data streams corresponding to frequency-shift keyed data encoded using PWM frequencies of 15 KHz for start and stop bits, 17 kHz for “zero” (logic low) and 19 kHz for “one” (logic high).

FIG. 8 illustrates generally a technique, such as a method, including generating an electrical signal to a propulsion motor including a portion corresponding to operating energy for the propulsion motor and a portion corresponding to a transmission signal to be acoustically transmitted by the propulsion motor.

FIG. 9 illustrates generally a technique, such as a method, including receiving a signal acoustically transmitted by a propulsion motor.

FIG. 10 illustrates generally an example comprising a navigational aid such as can be provided using acoustic transmission from a propulsion motor.

FIG. 11 illustrates a block diagram of an example comprising a machine upon which any one or more of the techniques (e.g., methodologies) discussed herein may be performed.

### DETAILED DESCRIPTION

Electric thrusters or “propulsors” on modern underwater and surface vehicles can be driven electrically by a control circuit that can generate Pulse Width Modulation (PWM) thruster control signals or other signals. In operation, an electric thruster generally produces an acoustic noise signature that can be related to the speed of the propeller and including noise corresponding to frequency components of the control signals and their harmonics. An electrical PWM signal can be transduced into an acoustic signal either by rapid variations in the vehicle thrust imposed on the fluid medium or by generating noise within the mechanical elements of the thruster (due to mechanical vibrations such as corresponding to magnetostriction or other mechanical oscillations of electrical components). During normal operation, a range of frequencies acoustically emitted by a thruster may range from about 5 kHz to about 30 kHz, as an illustrative example.

In this illustrative example, such noise is within the range of frequencies detectable using generally-available equipment such as hydrophones. In one approach, efforts can be made to reduce or suppress a noise signature of electric powered vehicles, such as to avoid nuisance or enhance stealthiness. By contrast, the present inventors have recognized that such a noise signature can be controlled to be selectively enhanced for communication (and, for example, suppressed in other circumstances), such as by adding a communication signal to a signal used for operating the motor or by modifying (e.g., modulating) the signal used to operate the motor. In this manner, otherwise parasitic noise emission from an electric thruster or other aquatic motor can be used to provide acoustic communication. A one-way communication scheme can be used such as for providing a navigational aid or beacon, as illustrative examples. For vehicles having at least one electric thruster and one hydrophone, a bi-directional communication scheme can be established using such resources.

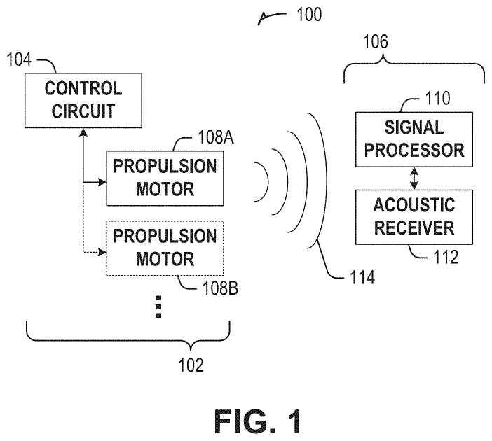

FIG. 1 illustrates generally an example comprising an electro-acoustic communication system 100 including a transmitter circuit 102 and a receiver circuit 106. The transmitter circuit 102 can be included as a portion of a vehicle such as a surface vessel or underwater vehicle. The surface vessel or underwater vehicle can be propelled by at least one electrically-powered propulsion motor 108A (or multiple propulsion motors 108A, 108B, and so on). Acoustic energy 114 can be emitted into a fluid medium by the propulsion motor. A control circuit 104, such as can include a microcontroller or microprocessor-based control circuit and associated power electronic devices (e.g., bridge circuits driven according to a control scheme established by a processor circuit or state machine) can be used to provide operating energy to the propulsion motor 108A. For example, the operating energy can be used by the propulsion motor to provide thrust.

As mentioned in relation to other examples herein, a portion of the electrical signal generated by the control circuit to the propulsion motor can include a transmission signal, such as added to the signal comprising operating energy for propulsion or achieved by modifying such an operating signal. The transmission signal can include encoded data or other information that is acoustically emitted to provide propagating acoustic energy 114.

In an example, a single electrically-operated propulsion motor 108A can acoustically emit one or more multiplexed data signals or other communication signals. In another example, respective electrically-operated propulsion motors 108A and 108B can emit separate data or other communication signals. For example, a first electrically-operated propulsion motor 108A can emit a first communication signal in a first direction, and a second electrically-operated propulsion motor 108B can emit a different second communication signal in a different second direction.

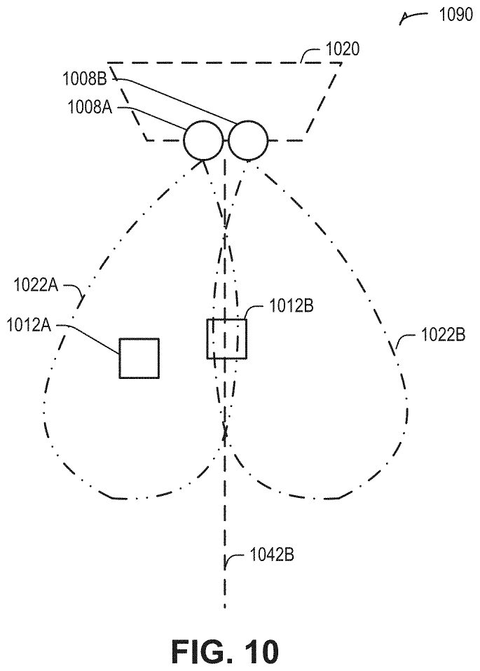

The receiver circuit 106 can include an acoustic receiver 112, such as a hydrophone or other acousto-electric transducer, electrically coupled to a signal processor circuit 110. The receiver circuit 106 can be included as a portion of an underwater vehicle or a surface vessel, such as an unmanned vehicle. The signal processor circuit 110 can process an electrical representation of a received signal corresponding to the transmission signal embedded in the acoustic energy 114, such as to determine at least one of a location, a distance, a relative bearing, or a locus of relative bearings, relative to the vehicle housing the electrically-powered propulsion motor. For example, as shown illustratively in FIG. 10, the signal processor circuit can be configured to determine a relative degree of angular error between the acoustic receiver location and a specified axis extending from the vehicle housing the electrically-powered propulsion motor, such as h comparing magnitudes of different received signals to each other in a manner similar to operation of an aviation localizer scheme. In another example, the signal processor circuit can be configured to decode commands or other information encoded in the transmission signal embedded in the acoustic energy 114.

The signal processor circuit 110 can include one or more sampling or analog-to-digital converter circuits, such as to provide a discrete-time representation of a signal received by the acoustic receiver 112. The signal processor circuit 110 can include one or more mixers or demodulators to process, detect, or convert a received signal into a form suitable for further processing. As an illustrative example, the signal processor circuit 110 can include a microcontroller or microprocessor-based digital signal processor, an application-specific digital signal processor circuit, a state machine, or a configurable logic device such as a field-programmable gate array, to provide efficient processing of received signals. The system 100 of claim can be used to perform techniques or otherwise provide communication as shown and described in relation to other examples herein.

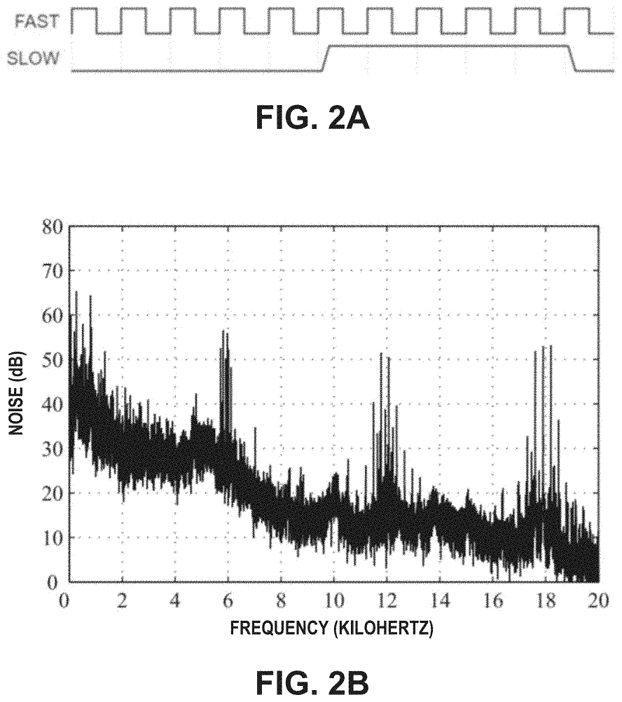

FIG. 2A shows illustrative examples of pulse-width modulation waveforms having the same duty cycle (and the same average value), but having different frequencies and FIG. 2B shows an illustrative example of a noise spectrum of a 6 kW motor being driven using a 6 kHz pulse-width-modulation (PWM) waveform. Generally, electrically-operated propulsion motors such as thrusters for surface vehicles or underwater vehicles produce acoustic noise during their operation. Such noise can include contributions from one or more sources such as noise generated by propeller cavitation, the flow of water around the vehicle body, propeller noise, or motor noise, as illustrative examples.

A speed of an electric propulsion motor can be controlled using an electronic circuit such as a Variable Speed Drive (VSD) or Electronic Speed Controller (ESC). An ESC can generate various chopped or pulse width modulated (PWM) signals, such as to control one or more of torque or motor speed. An unintended consequence of chopping or PWM is that an audible noise can generated by the motor during operation, such as corresponding to one or more of a fundamental frequency, a sub-multiple of a fundamental frequency, or a harmonic of a fundamental frequency appearing in one or more control signals. Such acoustic noise may even be generated when the thruster is not rotating or not providing propulsion. For example, a component of acoustic noise can be caused by the vibration of elements such as ferromagnetic laminations in a stator or a rotor of the motor, such as caused by the magnetic forces generated by the applied PWM signals. The frequency profile of acoustic energy emitted from motor can change in relation to the nature of the PWM waveform and can be detectable (e.g., audible) across a variety of motor configurations.

As an illustrative example, an electrically-operated propulsion motor can include a brushless direct-current (BLDC) motor. Generally, a BLDC motor comprises three or more windings (e.g., “phases”) that can each be driven by a respective half-bridge inverter stage or other power electronic circuit. An ESC can control the half-bridge stages to drive the motor windings roughly in phase with the rotation of the rotor. As an illustrative example, a 6-step commutation or 120-degree trapezoidal control scheme can be used. In this control scheme, current flows in two of the three phases at a time and the angle between the stator magnetic field and the rotor flux is driven towards 90 degrees to enhance or maximize torque. If the phasing of the winding currents is correct, the torque produced by the motor can be proportional to the winding current.

A current through each winding can be controlled using PWM. As the duty cycle of the PWM waveform varies from 0% to 100%, the stator current varies proportionately. Generally, the PWM frequency is much higher than the mechanical response of the motor, and therefore the frequency of the PWM signal is not critical to motor operation. Accordingly, from the standpoint of the motor, the “fast” and “slow” waveforms shown in FIG. 2A result in similar motor operation, when the period of such waveforms defines a PWM frequency beyond a mechanical response frequency of the motor (at least with respect to controlling motor rotation). As mentioned above, a PWM frequency used for driving the motor can cause emission of an acoustic signal at or near the PWM frequency.

In one approach, efforts can be made to reduce noise emitted acoustically from a thruster associated with use of PWM control, such as using spread spectrum modulation techniques to spread out the noise and reduce the amplitude of the noise peaks. In a similar manner, modulation of waveform characteristics such as period (e.g., corresponding to PWM frequency) can be used to encode information to be transmitted acoustically. Without being bound by theory, modulation of PWM signals is believed to support data rates approaching the PWM frequency, such as on the order of hundreds or thousands of bits per second. A representation of a capacity of a communication channel can be represented by the expression below:

Channel Capacity=2+BW*log₂(M) bits per second EQN. [1]

where BW can represent a bandwidth of a modulated baseband signal, and M can represent a number (e.g., a count) of bits per symbol.

A receiver to receive acoustic signals transmitted by a motor or thruster can include one or more of a hydrophone or a water-proofed microphone assembly. Various microphone configurations can be used, such as including one or more of a dynamic microphone, a condenser microphone, or a microelectromechanical (MEMS) microphone. A hydrophone or microphone can be modified to provide a frequency response including a peak frequency or band of frequencies specified to encompass a frequency corresponding to a PWM period (e.g., a PWM frequency).

Other frequencies can be rejected, such as to enhance a signal-to-noise ratio (or reduce a corresponding bit error rate) communication system using a modulated PWM signal. As an illustrative example, a PWM system might operate using a PWM frequency of 6 kHz as shown illustratively in the spectrum of FIG. 2B. Energy is present at the 6 kHz, operating frequency, along with its harmonics at 12 kHz and 18 kHz, for example. Motor operating current and motor operating speed generally correlate with a central tendency of the PWM signal (e.g., a corresponding to average value such as an equivalent “DC” level, or a root-mean-square value, as illustrative examples). Such a value of the PWM waveform is generally independent of the PWM frequency if such averaging or other determination is performed over an integral number of PWM periods. Accordingly, a significant shift in PWM frequency can be imposed and a PWM-driven motor will continue to operate normally in the presence of such a frequency shift.

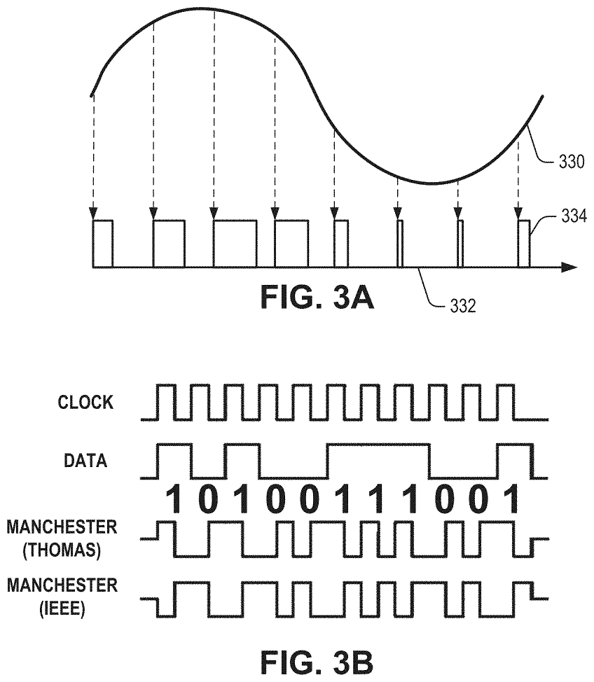

FIG. 3A shows an illustrative example of a sine wave 330 and a corresponding pulse-width-modulated representation 332 of the sine wave 330. A low-pass filtering behavior of a motor being driven using a PWM scheme may behave as if driven by a sine-wave-like current waveform in response to varying widths of the pulses in the PWM representation 332 (e.g., a pulse 334 corresponding to an intermediate amplitude portion of the sine wave 330 will have a corresponding intermediate pulse-width or duty cycle). If a duty cycle of a PWM waveform is specified to be, for example, 80%, then the output of the PWM waveform needs to be at logic “high” for 80% of the overall duration of the interval being considered. Whether an initial state of the signal is high or low will generally not impact motor performance.

As an example, in one communication approach, an edge polarity of the PWM waveform pulses can be controlled in a manner that encodes information. For example, a Manchester encoding scheme can be used, such as shown illustratively in FIG. 3B. A clock rate (e.g., a frequency corresponding to a period of a clock signal) can be established, such as corresponding to a PWM frequency. A data sequence (e.g., an illustrative example of a data signal to be transmitted) can be represented by the signal “DATA,” in FIG. 3B. A Manchester encoding scheme can establish edges transitions in encoded signals) having positive-going or negative-going edges to provide data encoding. In the example of FIG. 3B, a Manchester encoding of the data sequence according to G. F. Thomas is shown (“THOMAS”) along with a Manchester encoding of the data sequence according to IEEE 802.3 (corresponding to the IEEE 802.3-2018 Standard for Ethernet available from the Institute for Electrical and Electronics Engineers). Such examples of illustrative and other data modulation or encoding techniques can be used.

For example, one or more of phase modulation, frequency modulation, or amplitude modulation (or a combination thereof such as including a vector modulation scheme) can be used to encode information. For example, data can be acoustically transmitted by modulating the PWM frequency to provide Frequency Shift Keying (FSK), such as while the motor is also providing propulsion (e.g., the motor is operating). Binary Frequency Shift Keying (BFSK) can be implemented, such as using two different frequencies. If sufficient bandwidth is available, multiple frequencies can be used to transmit additional bits per symbol (e.g., a Multi-Frequency Shift Keying (MFSK) scheme). In another example, Binary Phase Shift Keying (BPSK) may be considered when implemented using a synchronization scheme and phase control to maintain motor operation.

In one approach, a modulation signal can be updated multiple times per a full mechanical rotation of the motor. In another example, such as at relatively higher rotation rates, modulation can be distributed over multiple rotations of the motor. Such an approach can be viewed as multi-cycle PWM modulation, or as an amplitude modulation scheme (e.g., corresponding to Amplitude Shift Keying (ASK)). For example, the motor or thruster can be cycled (powered on and off) rapidly, according to a specified bit-level encoding scheme. ASK is generally spectrally inefficient as compared to other approaches, but may be effective (e.g., meeting a specified data rate) as rotation rate increases in a corresponding manner.

Yet another pulse modulation scheme can include differential pulse position modulation, such as where the starting position of a pulse is adjusted based on the information signal to be transmitted. Pure pulse-position modulation generally involves synchronization of receiver and transmitter clocks. Differential pulse-position modulation (DPPM) temporally spaces each bit relative to the previous pulse, such as allowing the receiver to recover the information signal without a perfectly synchronized reference clock. In this manner, a DPPM modulation scheme provides simplicity of the circuitry that can be used to decode the received signals.

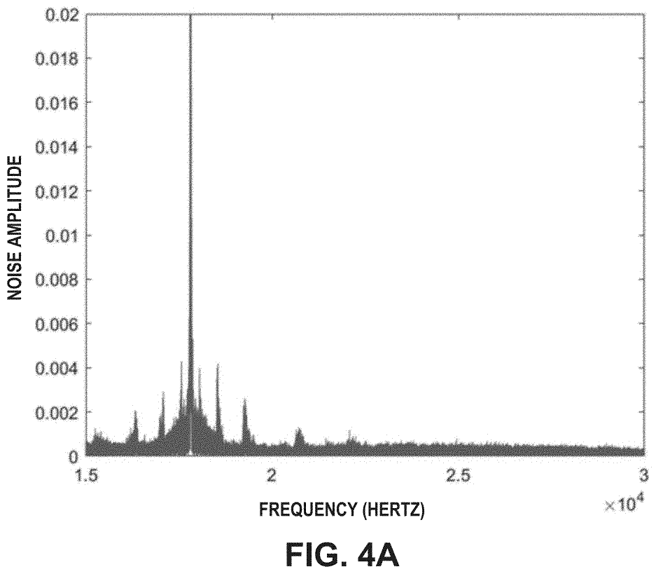

FIG. 4A shows an illustrative example of a 24 KHz spectrum corresponding to a PWM output from a Castle Creations Electronic Speed Controller (ESC), available from Castle Creations, Inc. (Olathe, Kans., United States). The spectrum shown in FIG. 4A was obtained within an outdoor body of water outdoor body of water with a depth of approximately 1.5 meters. A Blue Robotics T200 thruster (available from Blue Robotics, Inc., Los Angeles, Calif., United States) was selected as being representative of the thrusters on many smaller marine platforms as well as having publicly available characterization data. The thruster was mounted approximately one meter below the surface of the water. Similarly, FIG. 4B shows an illustrative example of a spectrum corresponding to a 17.5 kHz PWM output from an Afro ESC (available from HobbyKing.com. Hong Kong Special Administrative Region of the People's Republic of China). FIG. 4A and FIG. 4B show respective spectra illustrating frequency components produced by each of the ESCs, and such plots indicate that the two spectra are easily discernable from each other, with a 24 kHz peak shown in FIG. 4A, and a 17.5 kHz peak in relation to FIG. 4B. Side hands are present illustrating frequency components related to driving the propulsion motor (rather than transmitting an acoustic signal for purposes of communication).

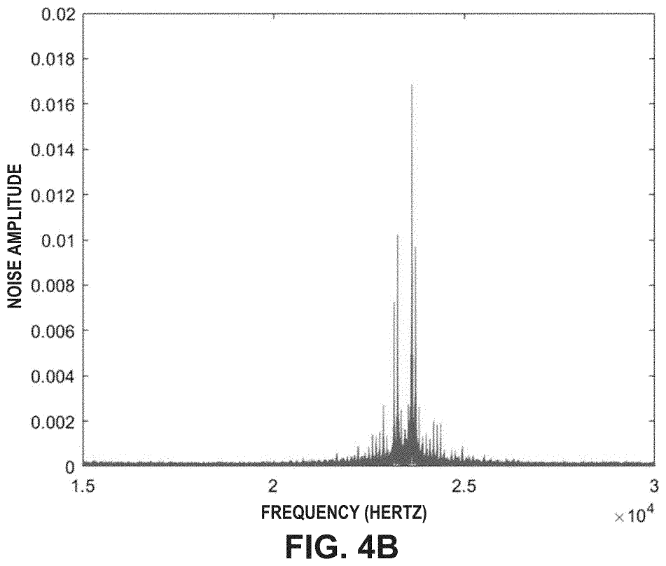

FIG. 5 shows an illustrative example of experimentally-detected amplitude-modulated data transmitted using a carrier frequency of 1080 Hertz (Hz), as received by a hydrophone when transmitted by an electrically-operated propulsion motor (e.g., the Blue Robotics T200). For this modulation scheme, an electrical signal used to drive the motor is generated using space vector modulation with a PWM frequency of 15 kHz. The carrier frequencies are created by repurposing some of the PWM pulses during commutation cycles to generate an acoustic tone. The duty-cycle of the repurposed PWM pulses modify the amplitude of the generated acoustic tone and represents an amplitude modulation scheme. Because of the pulse repurposing (e.g., use of existing temporal PWM pulse locations), a limited range of carrier frequencies can be generated. For example, repurposing every third PWM pulse results in a 5 kHz, tone (e.g., 15/3), but repurposing every 4th control pulse produces a 3750 Hz tone (e.g., 15/4). Higher frequencies can be generated at the expense of reduced motor control, in this illustrative example. The audio signals are produced by taking one of three motor phases to a high voltage relative to the two other phases or vice versa. In this configuration, currents through the motor phases combine to produce a tone but need not generate a net torque on the rotor.

The control loop of the space vector modulation control system can compensate for a loss of motor torque by increasing a pulse width of the remaining motor control pulses, such as in a scenario where the propulsion motor is providing propulsion and emitting a transmission signal for communication contemporaneously. Reflections or multipath may adversely affect a received signal amplitude, so in this example, the generated tones are amplitude modulated with a modulation index of either 0 or 100% (e.g., “on-off” keying). The motor driver controls the PWM duty-cycle any time tones are not being produced. To demonstrate operation of the communication system, an 8-bit packet containing the data sequence “10110001” was transmitted at 10 bits/second with the motor spinning at 500 revolutions per minute (RPM), For this example, a carrier frequency of 1080 Hz was selected. A representation of a measured acoustic signal after filtering for the carrier frequency is shown in FIG. 5. The data bits are clearly visible in the signal. In the scheme shown in FIG. 5, a return-to-zero encoding scheme is used after each bit. A non-return-to-zero modulation could be used. The bit sequence shown in FIG. 5 is not delimited using start or stop bits, but such bits could be included to aid detection.

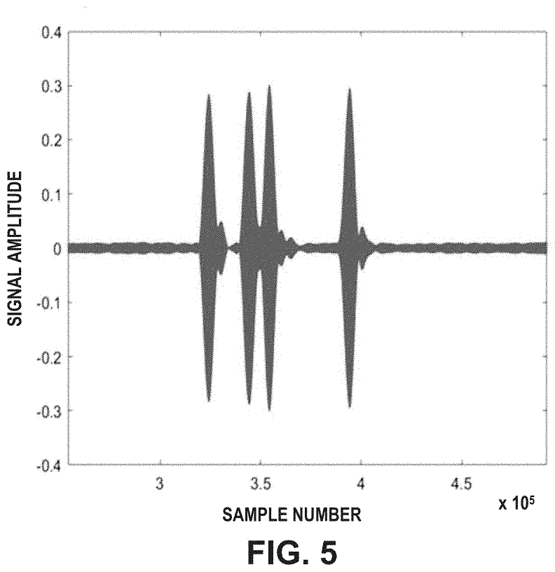

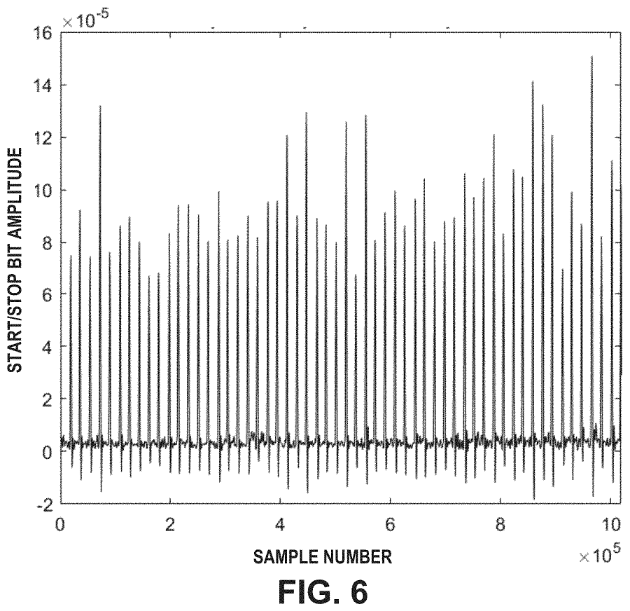

FIG. 6 shows an illustrative example of experimentally-detected start and stop bits corresponding to frequency-shift keyed data encoded using PWM frequencies of 15 kHz for start and stop bits, 17 kHz for “zero” (logic low) and 19 kHz for “one” (logic high) and FIG. 7 shows an illustrative example of experimentally-recovered data streams corresponding to frequency-shift keyed data encoded using PWM frequencies of 15 kHz for start and stop bits, 17 kHz for “zero” (logic low) and 19 kHz for “one” (logic high). As compared to amplitude modulation, a frequency modulation technique may be more robust to noise and reflections, Frequency-shift keying (FSK) is a form of frequency modulation. In this illustrative example (illustrated by FIG. 6 and FIG. 7), a three-tone FSK scheme is used, with 8-bit serial packets delimited by start and stop bits.

In this example, the start and stop bits are transmitted using a 1.5 kHz PWM frequency. The data bits are represented by PWM frequencies of 17 kHz and 19 kHz for logic low (e.g., zero) and logic high (e.g., one), respectively. A range of 10 meters between the transmitter and receiver was used, such as representative communication during a docking maneuver. The transmitted signals are detected by hydrophone and after sampling were fed into digital bandpass filters for each of the three FSK frequencies. After a square law detector, the signals were low-pass filtered to remove the carrier frequency. A bit-error-rate can be reduced or minimized by correctly detecting packet-delimiting start and stop bit signals. In FIG. 6, such start and stop bits are shown as spikes or peaks having varying amplitudes.

The acoustic transmitter (e.g., the propulsion motor) and the receiver (e.g., a hydrophone) were not moving during these observations, so observed amplitude variations may be a result of a short channel coherence length due to surface reflections. The temporal spacing between the start and stop bits corresponds to a packet length. In FIG. 7, the recovered signals are shown. A curve 762 represents the detected start and stop bits. The data rate is 250 bits per second and the transmitted sequence is “01010101.” A curve 766 represents the detected zeroes and a curve 764 represents the detected ones. In this experimental setup, a variation of up to plus-or-minus 8% variation in the packet length has been observed in the received data, relative to a nominal packet length. Without being bound by theory, this variation may be due to phase and frequency discontinuities associated with different data sequences that may impact state estimator using in a space vector modulation motor control scheme. In this illustrative example, measurements of continuous streams of data indicate a bit error rate of 2×10⁻⁵ for data sent at 250 bits-per-second and a bit error rate of about 4×10⁻³ for data sent at 500bits-per-second. Error correction, such as a forward error correction (FEC) code, could be used to drive the link bit error rates lower. A transmission rate and resulting bit error rate do not appear to be significantly affected by the rotation rate of the motor or the load on the motor. Experimental observations indicated some variation in data rate dependent on motor rotation rate, which may be attributable to interrupt behavior associated with a microprocessor used for motor control. Synchronization of data transmission with a motor control interrupt schedule may reduce or suppress such variation.

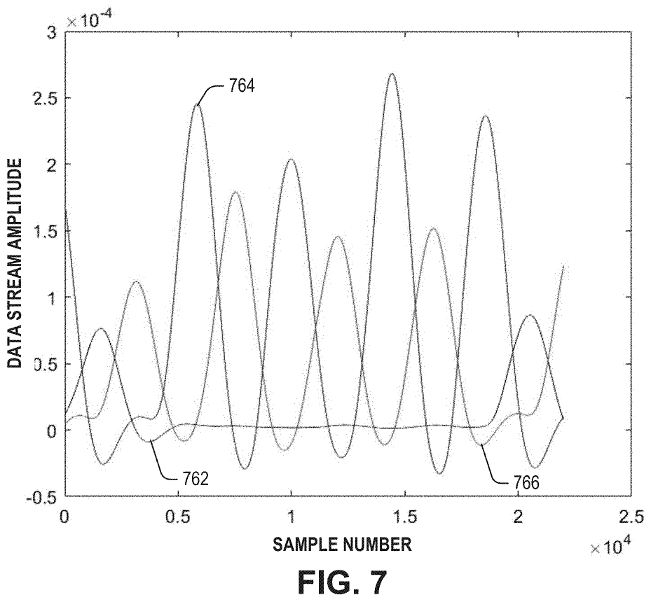

FIG. 8 illustrates generally a technique 800, such as a method, including at 805, generating an electrical signal to a propulsion motor, the electrical signal including a portion corresponding to operating energy for the propulsion motor and at 810, generating an electrical signal to the propulsion motor including a portion corresponding to a transmission signal to be acoustically transmitted by the propulsion motor for communication. The portion corresponding to operating energy can be generated contemporaneously with the portion to be acoustically transmitted for communication, such as shown and described in relation to other examples herein. For example, the portion for communication can include modifying signals used for operating the propulsion motor (e.g., by modifying one or more of a PWM pulse sequence, a phase, or a frequency used for PWM control as described elsewhere herein).

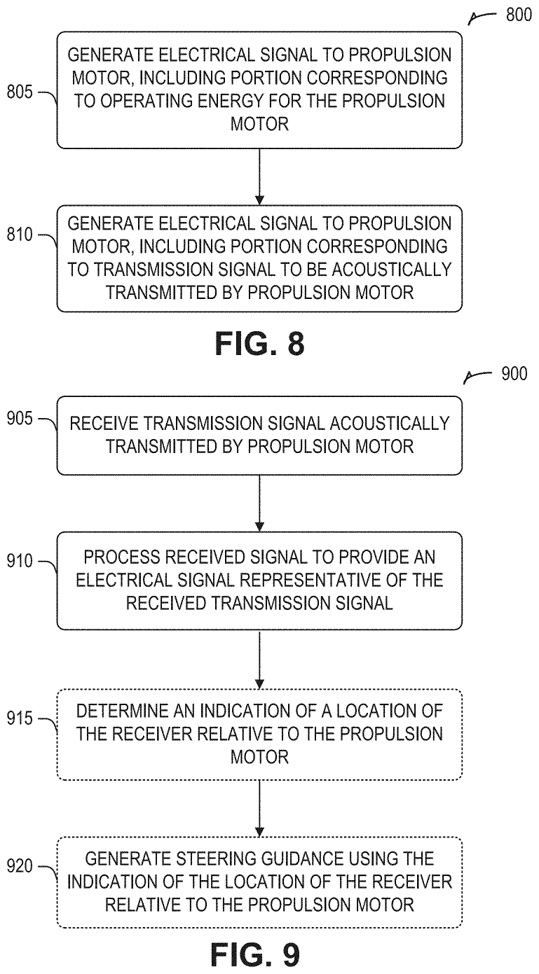

FIG. 9 illustrates generally a technique 900, such as a method, including receiving a signal acoustically transmitted by a propulsion motor at 905. The receiver can include a acousto-electric transducer such as a hydrophone. At 910, the received signal can be processed such as to provide an electrical signal representative of the received transmission signal. Such processing can include one or more of filtering, frequency conversion, digitization, decoding, or demodulation, as illustrative examples. Optionally, at 915, an indication of a location of the receiver relative to the propulsion motor can be determined, such as to facilitate rendezvous, docking, or recovery operations. For example, location information can include digitally-encoded information provided in the transmission signal received at 905, or such an indication can be, determined using a characteristic of the received transmission signal such as an amplitude, phase, or other received indicium, such as relative to a reference or relative to another signal. Optionally, at 920, steering guidance can be generated using the indication of the location of the receiver relative to the propulsion motor.

FIG. 10 illustrates generally an example comprising a navigational aid 1090 such as can be provided using acoustic transmission from propulsion motors 1008A and 1008B. The propulsion motors 1008A and 1008B can be located on or within a vehicle 1020 such as a submersible or a surface vessel, The various apparatus and techniques mentioned elsewhere in this document can be used to provide a system that can be used communication between collaborating surface or underwater vehicles. Modulating acoustic signals produced by propulsion motors (e.g., motors 1008A and 1008B) can yield a powerful transmitter for nominal increases in size, weight, power consumption, or cost. Such a system can be used as a communication. network for swarms of underwater vehicles and sensor platforms or for enabling communication between surface and underwater vehicles. As an illustrative example, such communication can facilitate recovery of an underwater vehicle by a surface vehicle. For example, one challenge in recovery is navigating the underwater vehicle into a position suitable for docking or other recovery operations.

In a manner similar to an aviation localizer or an aviation glideslope, the aid 1090 can provide guidance information to allow one or more other vehicles (e.g., a vehicle 1012A or a vehicle 1012B) to acquire location information concerning a relative angle (e.g., an angular “error”) with respect to an axis 1042B extending from the vehicle 1020 housing the propulsion motors 1008A and 1008B. For example, the propulsion motor 1008A can be located generally in a port direction relative to centerline axis 1042, and the propulsion motor 1008B can be located generally in a starboard direction. The first and second propulsion motors 1008A and 1008B can emit transmission signals acoustically to provide a first acoustic field 1022A corresponding to a first frequency, and a second acoustic field 1022B corresponding to a different second frequency. By modulating the propulsion motors or otherwise driving such motors 1008A and 1008B using different frequencies, a degree of angular error can be determined relative to the axis 1042.

As an illustration, a vehicle within at least one of the fields 1022A and 1022B can determine an indication of a received magnitude of a first modulation signal provided by the first propulsion motor 1008A as compared to a received magnitude of a second modulation signal provided by the second propulsion motor 1008B. For example, in the location shown for the vehicle 1012A, a received magnitude of the first modulation signal corresponding to the first field 1022A will be much greater than a magnitude of the received second modulation signal corresponding to the second field 102213. By contrast, in the location shown for the vehicle 1012B, the received magnitudes of the first and second modulation signals can be equal or about equal, indicating that the vehicle is aligned laterally with the axis 1042B. Generally, a difference in received signal magnitude can be used to determine the direction and magnitude of a course correction (e.g., steering guidance) to guide an underwater vehicle to the axis 10429 centered behind vehicle 1020. By maintaining a velocity greater than the vehicle 1020, the other vehicles 1012A or 1012B could even dock automatically or otherwise position themselves for recovery.

If the motors 1008A and 1008B would generally emit an omni-directional signal, a hull of the vehicle 1020 can be used to provide a barrier (e.g., to provide an acoustic shadow inhibiting or suppressing acoustic radiation in the direction toward the hull), such as by positioning the first and second propulsion motors 1008A and 1008B on opposite sides of the hull. Use of a single axis to provide lateral alignment is merely illustrative. The axis 1042B need not be parallel to a fluid surface (e.g., the water surface, and may be directed at a “slant angle” downward in a diagonal direction extending away from the vehicle 1020). Guidance can be provided in multiple axes using a scheme similar to the example of FIG. 10.

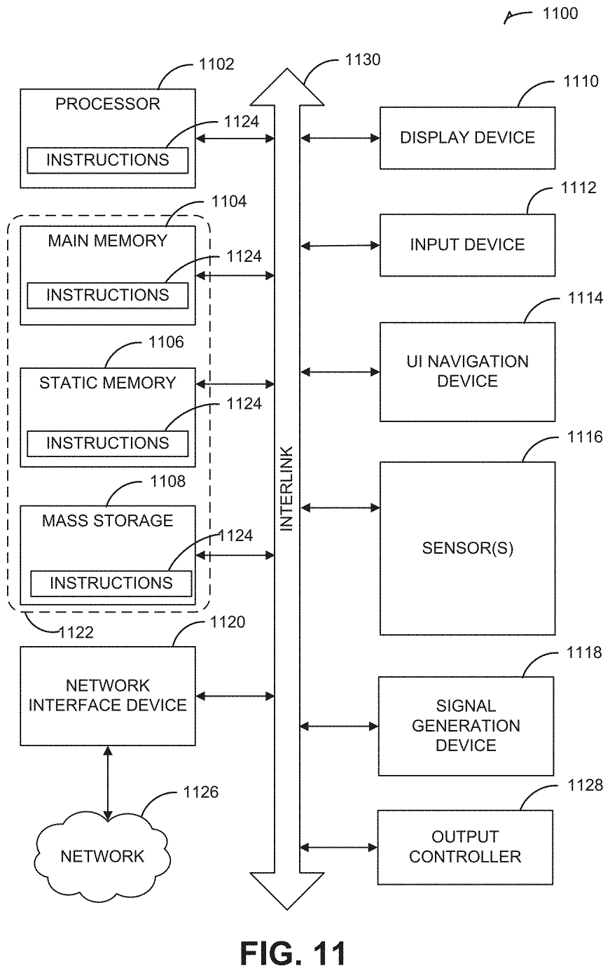

FIG. 11 illustrates a block diagram of an example comprising a machine 1100 upon which any one or more of the techniques (e.g., methodologies) discussed herein may be performed. In various examples, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment, The machine 1100 may be a personal computer (PC), a tablet device, a set-top box (STB), a personal digital assistant (PDA), a mobile telephone, a web appliance, a network router, switch or bridge, an embedded system such as located in an underwater or surface vehicle, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SUMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software.

### Various Notes

Each of the non-limiting aspects above can stand on its own, or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B.” unless otherwise indicated. In this document, the terms “including” and “in which” are used as the plain-English equivalents of the respective terms “comprising” and “wherein.” Also, in the following claims, the tern's “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMS), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An electromechanical communication system, comprising:
an electrically-powered propulsion motor mechanically coupled to a vehicle, the propulsion motor configured to provide mechanical propulsion in a fluid medium;
a control circuit coupled to the propulsion motor, the control circuit configured to generate an electrical signal to the propulsion motor including a portion corresponding to operating energy for the propulsion motor to use in providing thrust, and a portion corresponding to a transmission signal to be acoustically transmitted through the fluid medium by the propulsion motor acting as an electromechanical transducer.

2. The electromechanical communication system of claim 1, comprising an acoustic receiver configured to receive the transmission signal and to provide an electrical signal representative of the received transmission signal.

3. The electromechanical communication system of claim 2, wherein the fluid medium is water; and
wherein the acoustic receiver comprises an acousto-electric transducer.

4. The electromechanical communication system of claim 2, comprising a signal processor configured to process a signal received from the acoustic receiver to determine at least one of a location, a distance, a relative bearing, or a locus of relative bearings, relative to the vehicle housing the electrically-powered propulsion motor.

5. The electromechanical communication system of claim 4, wherein the signal processor is configured to determine a relative degree of angular error between an acoustic receiver location and a specified axis extending from the vehicle housing the electrically-powered propulsion motor.

6. The electromechanical communication system of claim 5, wherein the portion corresponding to the transmission signal includes a first modulation signal to be acoustically transmitted in a first direction and a different second modulation signal to be acoustically transmitted in a different second direction; and
wherein the signal processor is configured to determine the relative degree of angular error comprises determining a relative indication of a received magnitude of the first modulation signal as compared to a received magnitude of the second modulation signal.

7. The electromechanical communication system of claim I, wherein the portion corresponding to the transmission signal includes information encoded using a frequency modulation scheme.

8. The electromechanical communication system of claim 1, wherein the portion corresponding to the transmission signal includes information encoded using an edge polarity encoding scheme.

9. The electromechanical communication system of claim 1, wherein the portion corresponding to the transmission signal includes information encoded using an amplitude modulation scheme.

10. A method for controlling an electrically-powered propulsion motor, the propulsion motor configured to provide mechanical propulsion in a fluid medium, the method comprising:
generating an electrical signal to the propulsion motor including:
a portion corresponding to operating energy for the propulsion motor to use in providing thrust; and
a portion corresponding to a transmission signal to he acoustically transmitted by the propulsion motor acting as an electromechanical transducer.

11. The method of claim 10, wherein the portion corresponding to the transmission signal includes a first modulation signal to be acoustically transmitted in a first direction and a different second modulation signal to be acoustically transmitted in a different second direction.

12. The method of claim 10, wherein the portion corresponding to the transmission signal includes information encoded using at least one of a frequency modulation scheme, a frequency-shift keying (FSK) scheme, an edge-polarity encoding scheme, or an amplitude modulation scheme.

13. The method of claim 10, wherein the transmission signal is added to the portion corresponding to the operating energy for the propulsion motor.

14. The method of claim 10, wherein the transmission signal is established by modifying the portion corresponding to the operating energy.

15. A method for receiving an acoustic signal transmitted by an electrically-powered propulsion motor, the propulsion motor configured to provide mechanical propulsion in a fluid medium, the method comprising:
using an acoustic receiver, receiving a transmission signal acoustically transmitted by the propulsion motor acting as an electromechanical transducer;
processing the received signal to provide an electrical signal representative of the received transmission signal; and
using the electrical signal, determining an indication of a location of the acoustic receiver relative to the propulsion motor;
wherein the transmission signal is at least one of added to a signal corresponding to the operating energy for the propulsion motor or established by modifying the signal corresponding to the operating energy for the propulsion motor.

16. The method of claim 15, wherein the fluid medium is water; and
wherein the acoustic receiver comprises an acousto-electric transducer.

17. The method of claim 15, wherein determining the indication of the location of the receiver includes determining at least one of a location, a distance, a relative bearing, or a locus of relative bearings, relative to a vehicle housing the electrically-powered propulsion motor.

18. The method of claim 17, wherein determining the indication of the location of the receiver includes determining a relative degree of angular error with respect to a specified axis extending from the vehicle housing the electrically-powered propulsion motor.

19. The method of claim 18, wherein the transmission signal includes a first modulation signal acoustically transmitted in a first direction and a second different modulation signal acoustically transmitted in a second different direction; and
wherein determining the relative degree of angular error comprises determining a relative indication of a received magnitude of the first modulation signal as compared to a received magnitude of the second modulation signal.

20. The method of claim 15, comprising generating steering guidance using the indication of the location of the receiver relative to the propulsion motor.
